(19) United States
(12) Patent Application Publication
(10) Pub. No.: US 2026/0249843 A1
(43) Pub. Date: Aug. 27, 2026

(54) AUTONOMOUS VEHICLE AND METHOD FOR DRIVING OF AUTONOMOUS VEHICLE ON HIGH-CURVATURE CURVE

(71) Applicants: Hyundai Motor Company, Seoul (KR); Kia Corporation, Seoul (KR)

(72) Inventors: Je Kyung Lee, Hwaseong-si (KR); Jae Min Lee, Hwaseong-si (KR)

(21) Appl. No.: 19/302,968

(22) Filed: Aug. 18, 2025

(30) Foreign Application Priority Data
Feb. 24, 2025 (KR) 10-2025-0023616

(51) Int. Cl. B60W 30/12; B60W 10/11; B60W 30/14; B60W 60/00

(52) U.S. Cl. CPC B60W 30/12; B60W 10/11; B60W 30/14; B60W 60/001; B60W 2420/403; B60W 2510/1005; B60W 2520/10; B60W 2520/125; B60W 2552/30; B60W 2554/40; B60W 2556/40; B60W 2556/50; B60W 2710/1005

(57) ABSTRACT

According to the present disclosure, a control device for a vehicle may determine that the vehicle, which is traveling on a road with a curvature value above a threshold curvature value, is likely to depart from a driving lane in which the vehicle is traveling, based on a map of an area in which the vehicle is traveling, global positioning system (GPS) information associated with the vehicle, and a lateral acceleration of the vehicle; based on at least one of: the lateral acceleration of the vehicle, a speed of the vehicle, a gear ratio of a transmission of the vehicle, or a rotational speed of the transmission of the vehicle, determine that driving control is required for the vehicle; and control an autonomous driving operation of the vehicle by inhibiting upshifting in the transmission.

This application claims priority to Korean Patent Application No. 10-2025-0023616, filed in the Korean Intellectual Property Office on Feb. 24, 2025, the entire content of which is incorporated by reference for all purposes.

### TECHNICAL FIELD

The present disclosure relates to a vehicle and more specifically a method of controlling a vehicle.

### BACKGROUND

An autonomous vehicle may include a vehicle terminal that corresponds to an autonomous driving device that is embedded in various means of transportation and navigates around a location at which the vehicle is driving to enable autonomous driving. Autonomous driving devices have, in the past, been adopted in ships, airplanes, and the like, and they are now installed in many road vehicles to provide users with various information on driving routes, road congestion, and the like through a monitor. An autonomous driving device may control the vehicle to drive by itself (e.g., with little or no human intervention) or control the driving state of the vehicle.

When such an autonomous vehicle is driving at a high speed on a curved road having a high curvature (referred to as a high-curvature road herein), there is a risk that the vehicle may depart from its driving lane due to a centrifugal force. To prevent this, it may be necessary to reduce the speed when the autonomous vehicle is driving at a high speed on such a high-curvature road.

However, rapidly reducing the speed of the autonomous vehicle may degrade ride comfort and reduce the stability of the vehicle. It may thus be necessary to verify the road conditions and vehicle state when the vehicle is autonomously driving on a high-curvature road at a high speed, such that the vehicle does not depart from the lane without compromising ride comfort or driving stability.

The matters described in this Background section are only for enhancement of understanding of the background of the disclosure, and should not be taken as acknowledgement that they correspond to prior art already known to those skilled in the art.

### SUMMARY

An aspect of the present disclosure aims to, when an autonomous vehicle is driving on a high-curvature road at a high speed, verify the road conditions and vehicle state to decelerate the vehicle such that the vehicle does not depart from its driving lane without degrading ride comfort or driving stability.

According to one or more example embodiments of the present disclosure, a control device for a vehicle may include: a plurality of processors including a first processor, a second processor, and a third processor; and a memory storing at least one instruction. The at least one instruction may be configured, when executed by the first processor communicating with the memory, to cause the control device to: based on a map of an area in which the vehicle is traveling, global positioning system (GPS) information associated with the vehicle, and a lateral acceleration of the vehicle, determine that the vehicle, which is traveling on a road with a curvature value above a threshold curvature value, is likely to depart from a driving lane in which the vehicle is traveling. The at least one instruction may be configured, when executed by the second processor communicating with the memory, to cause the control device to: based on at least one of: the lateral acceleration of the vehicle, a speed of the vehicle, a gear ratio of a transmission of the vehicle, or a rotational speed of the transmission of the vehicle, determine that driving control is required for the vehicle. The at least one instruction may be configured, when executed by the first processor communicating with the memory, to cause the control device to: control, based on the determining that the vehicle is likely to depart from the driving lane and the determining that the driving control is required, an autonomous driving operation of the vehicle by inhibiting upshifting in the transmission.

The map may have a resolution that is above a threshold value or is associated with a navigation device.

The at least one instruction may be configured, when executed by the first processor communicating with the memory, to cause the control device to determine that the vehicle is likely to depart from the driving lane by: determining that the lateral acceleration of the vehicle is greater than or equal to a threshold value.

The at least one instruction may be configured, when executed by the second processor communicating with the memory, to cause the control device to determine that the driving control is required for the vehicle by: determining that the lateral acceleration of the vehicle is greater than or equal to a threshold value.

The at least one instruction may be configured, when executed by the second processor communicating with the memory, to cause the control device to determine that the driving control is required for the vehicle by: determining that the speed of the vehicle is greater than or equal to a threshold value.

The at least one instruction may be configured, when executed by the second processor communicating with the memory, to cause the control device to determine that the driving control is required for the vehicle by: determining that the rotational speed of the transmission is less than or equal to a threshold value.

The at least one instruction may be configured, when executed by the second processor communicating with the memory, to cause the control device to determine that the driving control is required for the vehicle by: determining that the gear ratio of the transmission is greater than or equal to a threshold value.

The at least one instruction may be configured, when executed by the third processor communicating with the memory, to further cause the control device to: control, based on a predetermined condition being satisfied while upshifting in the transmission is inhibited, a second autonomous driving operation of the vehicle by allowing upshifting in the transmission.

The predetermined condition may include at least one of: the speed of the vehicle being greater than or equal to a threshold speed, the rotational speed of the transmission being greater than or equal to a threshold rotational speed, or a time to collision (TTC) between the vehicle and a target vehicle being less than or equal to a threshold time duration.

According to one or more example embodiments of the present disclosure, a method performed by an apparatus of a vehicle may include: starting a cruise control operation of the vehicle; determining that the vehicle is traveling on a high-curvature road having a curvature value above a threshold curvature value; determining, by an autonomous driving controller of the apparatus and based on a determination that the vehicle is traveling on the high-curvature road, that the vehicle is likely to depart from a driving lane in which the vehicle is traveling; determining, based on a determination that the vehicle is likely to depart from the driving lane, that driving control is required for the vehicle; and controlling, based on a determination that the driving control is required for the vehicle, an autonomous driving operation of the vehicle by inhibiting upshifting in a transmission of the vehicle.

Determining that the vehicle is traveling on the high-curvature road may include: determining that the vehicle is traveling on the high-curvature road based on a map. The map may have a resolution that is above a threshold value or is associated with a navigation device.

Determining that the vehicle is likely to depart from the driving lane may include: determining that a lateral acceleration of the vehicle is greater than or equal to a threshold value.

Determining that the driving control is required for the vehicle may include: determining that the driving control is required for the vehicle based on at least one of: a lateral acceleration of the vehicle, a speed of the vehicle, a rotational speed of the transmission, or a gear ratio of the transmission.

Determining that the driving control is required for the vehicle may include: determining that a lateral acceleration of the vehicle is greater than or equal to a threshold value.

Determining that the driving control is required for the vehicle may include: determining that a speed of the vehicle is greater than or equal to a threshold value.

Determining that the driving control is required for the vehicle may include: determining that a rotational speed of the transmission is less than or equal to a threshold value.

Determining that the driving control is required for the vehicle may include: determining that a gear ratio of the transmission is greater than or equal to a threshold value.

The method may further include: controlling, based on a predetermined condition being satisfied while upshifting in the transmission is inhibited, a second autonomous driving operation of the vehicle by allowing upshifting in the transmission.

The predetermined condition may include at least one of: a speed of the vehicle being greater than or equal to a threshold speed, a rotational speed of the transmission being greater than or equal to a threshold rotational speed, or a time to collision (TTC) between the vehicle and a target vehicle being less than or equal to a threshold time duration.

According to one or more example embodiments of the present disclosure, a control device for a vehicle may include: at least one sensor including an inertial measurement sensor and a camera; a processor; and a memory. The memory may store at least one instruction that is configured, when executed by the processor communicating with the memory, to cause the control device to: start a cruise control operation of the vehicle; determine, based on measurements of the inertial measurement sensor and at least one image captured by the camera, that the vehicle is traveling on a high-curvature road having a curvature value above a threshold curvature value; during an autonomous driving operation of the vehicle, determine, based on a determination that the vehicle is traveling on the high-curvature road, that the vehicle is likely to depart from a driving lane in which the vehicle is traveling; determine, based on a determination that the vehicle is likely to depart from the driving lane, that driving control is required for the vehicle; and control, based on a determination that the driving control is required for the vehicle, an autonomous driving operation of the vehicle by inhibiting upshifting in a transmission of the vehicle.

### BRIEF DESCRIPTION OF THE DRAWINGS

FIG. 1 illustrates an example autonomous vehicle.

FIG. 2 illustrates a method of operating an example autonomous vehicle on a high-curvature road.

FIG. 3 shows an example computing system.

### DETAILED DESCRIPTION

Hereinafter, one or more example embodiments of the present disclosure will be described in detail with reference to the accompanying drawings. The example embodiment(s) are not construed as limiting the disclosure and should be understood to include all changes, equivalents, and replacements within the idea and the technical scope of the disclosure. In describing the example embodiment(s) disclosed herein, detailed descriptions of related known art are omitted where it is deemed that such detailed description would obscure the essence of the example embodiment(s) disclosed herein. Further, the accompanying drawings are intended to facilitate an understanding of the example embodiment(s) disclosed herein, and the technical ideas disclosed herein are not limited by the accompanying drawings.

In describing the example embodiment(s), when an element is described as formed “above/on” or “below/under” another element, it may be construed that they are in direct contact, or they are in indirect contact with one or more other elements disposed therebetween. In this case, the use of “above/on” or “below/under” may be based on what is shown in the accompanying drawings, and these terms are used only to indicate a relative positional relationship between elements for the ease of description but may not be used to limit the actual positions of the elements.

For purposes of this application and the claims, using the exemplary phrase “at least one of: A; B; or C” or “at least one of A, B, or C,” the phrase means “at least one A, or at least one B, or at least one C, or any combination of at least one A, at least one B, and at least one C. Further, exemplary phrases, such as “A, B, or C”, “at least one of A, B, and C”, “at least one of A, B, or C”, etc. as used herein may mean each listed item or all possible combinations of the listed items. For example, “at least one of A or B” may refer to (1) at least one A; (2) at least one B; or (3) at least one A and at least one B.

An automation level of an autonomous driving vehicle may be classified as follows, according to the American Society of Automotive Engineers (SAE). At autonomous driving level 0, the SAE classification standard may correspond to “no automation,” in which an autonomous driving system is temporarily involved in emergency situations (e.g., automatic emergency braking) and/or provides warnings only (e.g., blind spot warning, lane departure warning, etc.), and a driver is expected to operate the vehicle. At autonomous driving level 1, the SAE classification standard may correspond to “driver assistance,” in which the system performs some driving functions (e.g., steering, acceleration, brake, lane centering, adaptive cruise control, etc.) while the driver operates the vehicle in a normal operation section, and the driver is expected to determine an operation state and/or timing of the system, perform other driving functions, and cope with (e.g., resolve) emergency situations. At autonomous driving level 2, the SAE classification standard may correspond to “partial automation,” in which the system performs steering, acceleration, and/or braking under the supervision of the driver, and the driver is expected to determine an operation state and/or timing of the system, perform other driving functions, and cope with (e.g., resolve) emergency situations. At autonomous driving level 3, the SAE classification standard may correspond to “conditional automation,” in which the system drives the vehicle (e.g., performs driving functions such as steering, acceleration, and/or braking) under limited conditions but transfer driving control to the driver when the required conditions are not met, and the driver is expected to determine an operation state and/or timing of the system, and take over control in emergency situations but do not otherwise operate the vehicle (e.g., steer, accelerate, and/or brake). At autonomous driving level 4, the SAE classification standard may correspond to “high automation,” in which the system performs all driving functions, and the driver is expected to take control of the vehicle only in emergency situations. At autonomous driving level 5, the SAE classification standard may correspond to “full automation,” in which the system performs full driving functions without any aid from the driver including in emergency situations, and the driver is not expected to perform any driving functions other than determining the operating state of the system. Although the present disclosure may apply the SAE classification standard for autonomous driving classification, other classification methods and/or algorithms may be used in one or more configurations described herein. One or more features associated with autonomous driving control may be activated based on configured autonomous driving control setting(s) (e.g., based on at least one of: an autonomous driving classification, a selection of an autonomous driving level for a vehicle, etc.).

Based on one or more features (e.g., detecting lane departure based on map information) described herein, an operation of the vehicle may be controlled. The vehicle control may include various operational controls associated with the vehicle (e.g., autonomous driving control, sensor control, braking control, braking time control, acceleration control, acceleration change rate control, alarm timing control, forward collision warning time control, etc.).

One or more auxiliary devices (e.g., engine brake, exhaust brake, hydraulic retarder, electric retarder, regenerative brake, etc.) may also be controlled, for example, based on one or more features (e.g., detecting lane departure based on map information) described herein. One or more communication devices (e.g., a modem, a network adapter, a radio transceiver, an antenna, etc., that is capable of communicating via one or more wired or wireless communication protocols, such as Ethernet, Wi-Fi, near-field communication (NFC), Bluetooth, Long-Term Evolution (LTE), 5G New Radio (NR), vehicle-to-everything (V2X), etc.) may also be controlled, for example, based on one or more features (e.g., detecting lane departure based on map information) described herein.

Minimum risk maneuver (MRM) operation(s) may also be controlled, for example, based on one or more features (e.g., detecting lane departure based on map information) described herein. A minimal risk maneuvering operation (e.g., a minimal risk maneuver, a minimum risk maneuver) may be a maneuvering operation of a vehicle to minimize (e.g., reduce) a risk of collision with surrounding vehicles in order to reach a lowered (e.g., minimum) risk state. A minimal risk maneuver may be an operation that may be activated during autonomous driving of the vehicle when a driver is unable to respond to a request to intervene. During the minimal risk maneuver, one or more processors of the vehicle may control a driving operation of the vehicle for a set period of time.

Biased driving operation(s) may also be controlled, for example, based on one or more features (e.g., detecting lane departure based on map information) described herein. A driving control apparatus may perform a biased driving control. To perform a biased driving, the driving control apparatus may control the vehicle to drive in a lane by maintaining a lateral distance between the position of the center of the vehicle and the center of the lane. For example, the driving control apparatus may control the vehicle to stay in the lane but not in the center of the lane.

The driving control apparatus may identify a biased target lateral distance for biased driving control. For example, a biased target lateral distance may comprise an intentionally adjusted lateral distance that a vehicle may aim to maintain from a reference point, such as the center of a lane or another vehicle, during maneuvers such as lane changes. This adjustment may be made to improve the vehicle's stability, safety, and/or performance under varying driving conditions, etc. For example, during a lane change, the driving control system may bias the lateral distance to keep a safer gap from adjacent vehicles, considering factors such as the vehicle's speed, road conditions, and/or the presence of obstacles, etc.

An autonomous driving level and/or autonomous driving activation/deactivation may also be controlled, for example, based on one or more features (e.g., detecting lane departure based on map information) described herein. A driving control apparatus may perform an autonomous driving level control (e.g., a change of an autonomous driving level, a change of a required user attentiveness, etc.) or cause deactivation of an autonomous driving operation. For example, by changing the required user attentiveness, the driver may be required to place his/her hands on the driving wheel more often (e.g., at least once in a threshold time period, such as five second, 30 seconds, 1 minute, etc.). By changing the required user attentiveness, the driver may be required to look ahead more often (e.g., at least once in a threshold time period, such as five second, 30 seconds, 1 minute, etc.). By changing the autonomous driving level, one or more video contents may not be displayed on a display of the vehicle.

One or more sensors (e.g., IMU sensors, camera, LIDAR, RADAR, blind spot monitoring sensor, line departure warning sensor, parking sensor, light sensor, rain sensor, traction control sensor, anti-lock braking system sensor, tire pressure monitoring sensor, seatbelt sensor, airbag sensor, fuel sensor, emission sensor, throttle position sensor, inverter, converter, motor controller, power distribution unit, high-voltage wiring and connectors, auxiliary power modules, charging interface, etc.) may also be controlled, for example, based on one or more features (e.g., detecting lane departure based on map information) described herein.

An operation control for autonomous driving of the vehicle may include various driving control of the vehicle by the vehicle control device (e.g., acceleration, deceleration, steering control, gear shifting control, braking system control, traction control, stability control, cruise control, lane keeping assist control, collision avoidance system control, emergency brake assistance control, traffic sign recognition control, adaptive headlight control, driver warning control, autonomous driving operational design domain (ODD), etc.). For example, the operation control for autonomous driving of the vehicle may be to inhibit gear shifting (e.g., upshifting) in a transmission.

The vehicle that an autonomous driving system is actively controlling may be referred to as an ego vehicle, a host vehicle, or an autonomous vehicle. The ego vehicle may also be referred to as a self-driving car, an autonomous car (AC), a driverless car, a robo-taxi, a robotic car, or a robo-car. The ego vehicle may be the vehicle that is equipped with the autonomous driving system. A car that is ahead of the ego vehicle (e.g., in the same driving lane as the ego vehicle) may be referred to as a vehicle in front, a lead vehicle, a leading vehicle, or a preceding vehicle. A car that follows the ego vehicle (e.g., in the same driving lane as the ego vehicle) may be referred to as a car behind, a trailing vehicle, or a succeeding vehicle. An adjacent vehicle may refer to any vehicle located in any direction (e.g., front, rear, left, right, diagonal, etc.) from the ego vehicle as long as no other vehicles (e.g., intervening vehicles) exist between it and the ego vehicle (e.g., regardless of the distance from the ego vehicle). Alternatively, in some contexts, only those vehicles that are located within a threshold distance (e.g., line of sight and/or detection limit of one or more sensors of the ego vehicle) from the ego vehicle may be referred to as adjacent vehicles. A target vehicle may be any vehicle that is near the ego vehicle (e.g., within a threshold distance away from the ego vehicle). The target vehicle may be any vehicle that the autonomous driving system monitors, recognizes, identifies, tracks, and/or analyzes, either actively or passively, either once or multiple times, and either sporadically or continuously. The threshold distance may be, for example, the line of sight and/or the detection limit of one or more sensors of the ego vehicle, but the threshold distance may be a value (e.g., an adjustable value) that is less than the line of sight and/or the detection limit of the one or more sensors of the ego vehicle. The target vehicle can be, for example, a vehicle in front, a vehicle behind, a vehicle in a different lane than the driving lane of the ego vehicle (e.g., a vehicle to the left, a vehicle to the right, a vehicle in a diagonal direction, etc.), and/or an adjacent vehicle (e.g., regardless of the distance from the ego vehicle and/or regardless of whether there are intervening vehicle(s) between the target vehicle and the ego vehicle). A target vehicle may also be referred to as a surrounding vehicle, a nearby vehicle, an external vehicle, another vehicle (other vehicles), and so forth.

An autonomous vehicle and a method of driving an autonomous vehicle on a high-curvature road may determine, if the autonomous vehicle is driving on a curved road with high curvature (also referred to as a high-curvature road) during autonomous driving of the vehicle, whether the vehicle is likely to depart from the road (e.g., depart from a driving lane in which the vehicle is driving) and control the driving of the vehicle if the vehicle is determined to be likely to depart from the road (e.g., a driving lane). A high-curvature road may refer to a road (or a section of a road) having a degree of curvature or a radius of curvature above a predetermined threshold value (e.g., having a curvature value above a threshold curvature value).

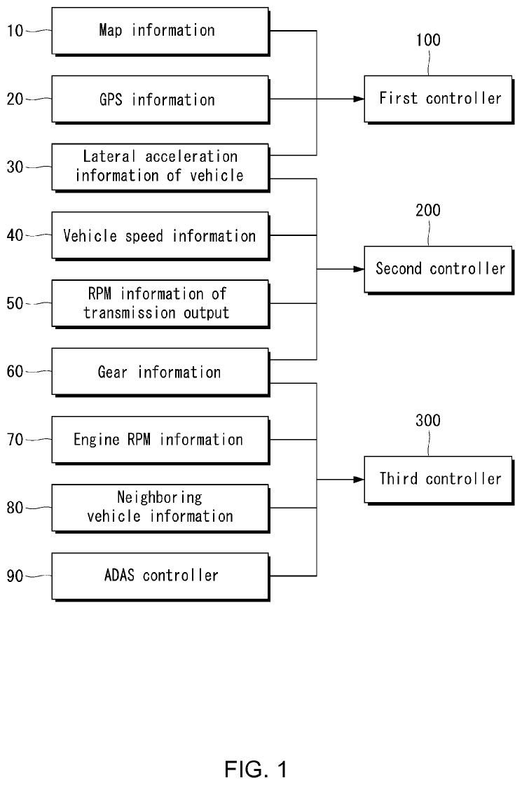

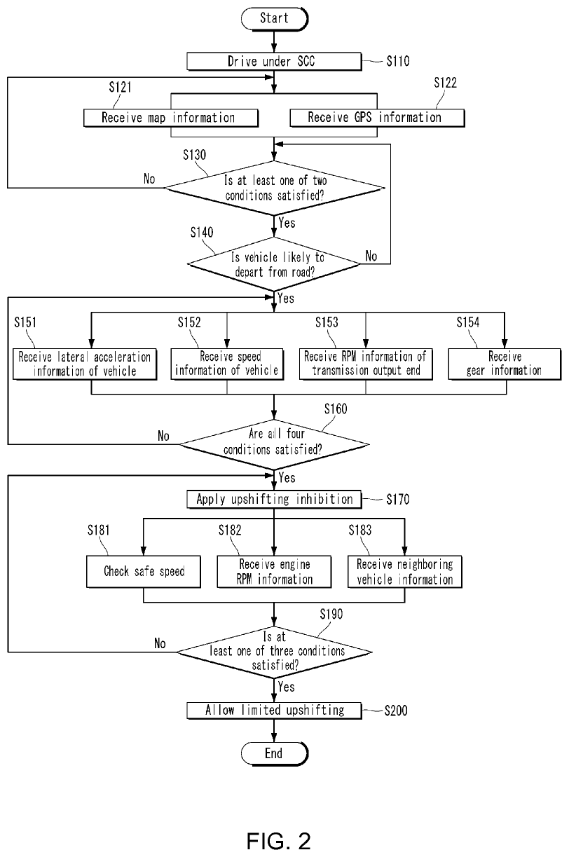

FIG. 1 illustrates an example autonomous vehicle, and FIG. 2 illustrates a method of operating an example autonomous vehicle on a high-curvature road. Hereinafter, the autonomous vehicle and the method of driving the autonomous vehicle on a high-curvature road will be described with reference to FIGS. 1 and 2 according to the present disclosure.

In FIG. 1, the map information may be provided by a map data provider (e.g. a memory storing map data), global positioning system (GPS) information by a GPS device, the lateral acceleration information (e.g., a lateral acceleration value) by a lateral accelerator (or accelerometer), speed information (e.g., a speed) by a speed sensor or a wheel sensor (e.g., rotation sensor), revolutions per minute (RPM) information (e.g., a rotational speed) and the gear information by a transmission controller, and the engine RPM information by an engine controller, without being limited thereto.

The vehicle may first perform autonomous driving (e.g., perform one or more autonomous driving operations) under, for example, smart cruise control (SCC), at step S110.

The vehicle may retrieve map information of an area in which the vehicle is currently traveling or is about to travel at step S121. The map information may be, for example, high-definition (HD) map information (e.g., a map having a resolution above a threshold resolution) or map information of a navigation device. That is, a first controller 100 may receive the map information 10 of the area in which the vehicle is currently traveling or is about to travel, and locate the vehicle on a corresponding map based on location information of the vehicle to determine whether the area corresponds to a high-curvature road. The map may be stored in a non-transitory memory in the vehicle or updated by receiving map data, regularly or if required or in real time, from an external server via wireless communication.

The vehicle may also retrieve global positioning system (GPS) information at step S122. The first controller 100 may determine whether the area in which the vehicle is currently traveling or is about to travel is a high-curvature road based on GPS information 20 from a GPS device (e.g. GPS receiver) installed in the vehicle or a terminal device, and a corresponding result may be displayed on a navigation device (e.g. audio video navigation system) of the vehicle. In this case, if a navigation-based smart cruise control (NSCC) is in use, the location of the vehicle may be determined in real time via the navigation device. One or both of steps S121 and S122 may be performed. If steps S121 and S122 are both performed, they may be performed in any order and/or concurrently.

Based on the map information or GPS information described above, the first controller 100 may determine whether the vehicle is traveling on a high-curvature road. The high-curvature road may be, for example, a circuit (e.g., a racing track) or an automobile road. The high-curvature road, or a high-curvature curve, described herein may refer to a road with a curvature of a predetermined value (e.g., threshold value) or greater, and a high curvature may be set differently depending on the temperature, rain, or snowfall, in addition to geometric settings.

The first controller 100 may determine whether the vehicle is traveling on a high-curvature road at step S130, and may determine whether the vehicle is likely to depart from the road (e.g., from the driving lane) at step S140 if the vehicle is determined to travel on the high-curvature road from at least one of the map information or the GPS information (S140: Yes) received at steps S121 and S122 described above.

In this case, if the first controller 100 receives lateral acceleration information 30 of the vehicle and a lateral acceleration of the vehicle is relatively large, a probability that the vehicle may depart from the high-curvature road (e.g., from the driving lane) on which it is traveling may increase. Therefore, if the lateral acceleration of the vehicle is greater than or equal to a predetermined first value (e.g., a first threshold value), the vehicle may be determined to be likely to depart from the road (S140: Yes).

At the above step, if the vehicle is likely to depart from the road while traveling on the high-curvature road, it may be determined whether driving control is actually required for the vehicle. Specifically, whether the driving control is required for the vehicle may be determined based on the lateral acceleration information, speed information, revolutions per minute (RPM) information of an output of a transmission, and gear information of the vehicle (i.e. the transmission).

The vehicle may first determine whether the lateral acceleration of the vehicle is greater than or equal to a second value at step S151. In other words, if the lateral acceleration of the vehicle is large, the vehicle may be more likely to depart from the high-curvature road on which it is traveling, requiring the driving control. In this case, a second controller 200 may receive the lateral acceleration information 30 of the vehicle and may, if the lateral acceleration of the vehicle is greater than or equal to a predetermined second value (e.g., a second threshold value) (Yes), determine that it is necessary to control the driving of the vehicle. The second value may be the same as the first value used at step S140 described above.

The vehicle may then determine whether the speed of the vehicle is greater than or equal to a third value at step S152. In other words, if the speed of the vehicle is extremely high, the vehicle may be more likely to depart from the high-curvature road on which it is traveling, requiring the driving control. In this case, the second controller 200 may receive speed information 40 of the vehicle and may, if the speed of the vehicle is greater than or equal to a predetermined third value (e.g., a third threshold value) (Yes), determine that it is required to control the driving of the vehicle.

The vehicle may also determine whether RPM of the output of the transmission is less than or equal to a fourth value (e.g., a fourth threshold value) at step S153. In other words, if the RPM of the transmission output is relatively small, the vehicle may receive a large driving force and be more likely to depart from the high-curvature road (e.g., from the driving lane) on which it is traveling. In addition, there may also be some cases where the RPM is maintained low while the vehicle is driving at a high speed. In this case, the second controller 200 may receive RPM information 50 of the transmission output and determine whether the RPM of the transmission output is less than or equal to the fourth value.

The vehicle may also determine whether a gear stage (also referred to as a gear position, a gear phase, or a gear ratio) of the vehicle (e.g., the transmission) is greater than or equal to a fifth value (e.g. a predetermined gear level (e.g., gear stage, gear position, gear phase)) at step S154. In other words, if the gear stage of the vehicle is extremely high (e.g., greater than a predetermined value), the vehicle may drive (e.g., travel) at a high speed and be more likely to depart from the high-curvature road (e.g., from the driving lane). In this case, the second controller 200 may receive gear information 60 of the vehicle and determine whether the gear stage of the vehicle is greater than or equal to the fifth value.

The vehicle may determine whether the information obtained at steps S151 to S154 described above satisfies all the conditions described above at step S160. If the conditions are all satisfied (S160: Yes) at steps S151 to S154 described above, the vehicle may determine that it is required to control the driving of the vehicle and may control the driving of the vehicle by, for example, inhibiting upshifting in the transmission at step S170.

That is, if the above conditions are satisfied so that the vehicle is traveling on the high-curvature road during autonomous driving, it is likely to depart from the road(e.g., from the driving lane), and it is thus determined that the driving control is required, a third controller 300 may inhibit the gear of the vehicle from upshifting to prevent the vehicle from accelerating, thereby preventing the vehicle from departing laterally from the high-curvature road.

Although FIG. 1 illustrates the first controller 100 through the third controller 300 separately from each other, any two or three of them may be integrated as a single controller in the vehicle.

If the autonomous vehicle is traveling with the upshifting inhibited as described above, there may occur some situations where the upshifting is required to be exceptionally allowed. To this end, the vehicle may determine whether the speed of the vehicle is greater than or equal to a predetermined safe speed at step S181, whether the RPM information of the vehicle is greater than or equal to a sixth value at step S182, or whether a time to collision (TTC) between the vehicle and a neighboring vehicle (e.g., a target vehicle) is less than or equal to a seventh value at step S183.

The above three conditions are example exceptional conditions for allowing the upshifting. For example, the upshifting may be allowed if the speed of the vehicle is greater than or equal to the safe speed.

The safe speed, for example, may be a limit speed which may be determined according to the chassis characteristics of the vehicle and may be set to be higher for a higher-performance vehicle. The third controller 300 may verify safe speed information according to a target speed of the vehicle or curvature of the road via an advanced driver assistance system (ADAS) controller 90 or the like, and may change a path of the vehicle at a faster speed by upshifting the gear if the speed of the vehicle is greater than the safe speed.

The third controller 300 may receive engine RPM information 70 of the vehicle and may allow the upshifting of the gear such that the power generated by the engine of the vehicle may be used for high-speed driving of the vehicle because greater power is generated by the engine if the engine RPM of the vehicle is greater than or equal to the sixth value.

The third controller 300 may also receive neighboring vehicle information 80 and may, if a TTC with a neighboring vehicle is less than or equal to the seventh value, allow the gear stage of the vehicle to upshift, such that the vehicle may avoid a potential collision with the neighboring vehicle while driving at a high speed. In this case, the neighboring vehicle information may be obtained from a camera, a radar, and a lidar sensor provided in the vehicle, by which a distance from the neighboring vehicle and a driving speed of the neighboring vehicle may be obtained, allowing the third controller 300 to calculate the TCC.

If, after verifying the three conditions at steps S181 to S183 described above, at least one of the three conditions is satisfied at step S190 (S190: Yes), the vehicle may allow a limited upshift of the gear at step S200. In this case, allowing the limited upshift of the gear may indicate that the upshift of the gear is allowed only up to a specific gear level. If one or more three conditions are unsatisfied (e.g., all three conditions are not satisfied) (S190: No) at steps S181 to S183, the vehicle may continue inhibiting the upshift of the gear and driving at step S170.

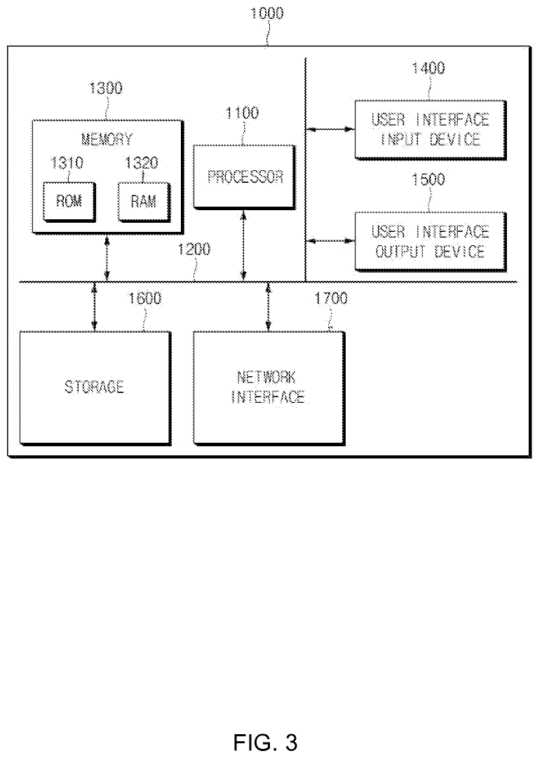

FIG. 3 shows an example computing system (e.g., a computing device of a vehicle or any other apparatus). One or more controllers, processors, etc. described herein may be implemented by the computing system or may be implemented in the computing system. For example, the first, second, and/or third controller may be implemented with a computing system 1000 as shown in FIG. 3. The first, second, and/or third controller may, for example, include a computer-readable recording medium that stores computer-readable instructions, and one or more processors configured to execute the computer-readable instructions which, when executed by the one or more processors, cause the controller to perform its functionality as described above.

The computing system 1000 may include at least one processor 1100, memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read-only memory (ROM) and a random access memory (RAM).

Communication interface(s) (also referred to as communication device(s), communicator(s), communication module(s), communication unit(s), etc.), such as the network interface 1700, may allow software and/or data to be transferred between a device and one or more external devices, and/or between one or more components of a device. Communication interface(s) may include a receiver, a transmitter, a transceiver, a modem, a network interface and/or adapter (such as an Ethernet adapter), a radio transceiver, an antenna, a communication port, a Personal Computer Memory Card International Association (PCMCIA) slot and card, or the like. Software and data transferred via communication interface(s) may be in the form of signals, which may be electronic, electromagnetic, optical, infrared, or other signals capable of being received by communication interface(s). These signals may be provided to communication interface(s) via a communication path of a device, which may be implemented using, for example, wire or cable, fiber optics, a cellular link, a radio frequency (RF) link and/or other communications channels. Communication interface(s) may communicate using one or more communication protocols, such as Ethernet, Wi-Fi, near-field communication (NFC), Infrared Data Association (IrDA), Bluetooth, Bluetooth low energy (BLE), Zigbee, Long-Term Evolution (LTE), 5G New Radio (NR), vehicle-to-everything (V2X), a controller area network (CAN), or a local interconnect network (LIN), etc.

Accordingly, the operations of the method or algorithm described in connection with example embodiment(s) disclosed in the specification may be directly implemented with a hardware module, a software module, or a combination of the hardware module and the software module, which is executed by the processor 1100. The software module may reside on a storage medium (i.e., the memory 1300 and/or the storage 1600) such as RAM, a flash memory, ROM, an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

An autonomous vehicle includes a first controller configured to make a first determination that the vehicle is likely to depart from a high-curvature curved road on which the vehicle travels based on map information of an area in which the vehicle is driving and global positioning system (GPS) information associated with the vehicle and lateral acceleration information of the vehicle, a second controller configured to make a second determination that driving control is required for the vehicle based on the lateral acceleration information, speed information, gear information, revolutions per minute (RPM) information of an output of a transmission of the vehicle, and a third controller configured to inhibit upshifting in the transmission based on the first determination and the second determination.

The map information may include high-definition map information or map information of a navigation device.

The first controller may be configured to make the first determination based on a lateral acceleration of the vehicle being greater than or equal to a first value.

The second controller may be configured to make the second determination based on a lateral acceleration of the vehicle being greater than or equal to a second value.

The second controller may be configured to make the second determination based on a speed of the vehicle being greater than or equal to a third value.

The second controller may be configured to make the second determination based on an RPM of the transmission output being less than or equal to a fourth value.

The second controller may be configured to make the second determination based on a gear stage of the transmission being higher than or equal to a predetermined gear level.

The third controller may be configured to allow the upshifting based on a predetermined condition being satisfied during the inhibition.

The third controller may be configured to determine that the predetermined condition is satisfied when the speed of the vehicle is greater than or equal to a predetermined speed, the RPM information is greater than or equal to a sixth value, or a time to collision (TTC) between the vehicle and a neighboring vehicle is less than or equal to a seventh value.

A method of driving an autonomous vehicle on a high-curvature curved road, the method includes starting smart cruise control (SCC) of the vehicle, determining that the vehicle is driving on a high-curvature curved road, determining, based on a determination that the vehicle is driving on the high-curvature curved road, that the vehicle is likely to depart from the road, determining, based on a determination that the vehicle is likely to depart from the road, that driving control is required for the vehicle, and inhibiting upshifting in a transmission of the vehicle based on a determination that the driving control is required for the vehicle.

The determining that the vehicle is driving on the high-curvature curved road may include determining, based on high-definition map information or map information of a navigation device in association with an area in which the vehicle is driving, that the vehicle is driving on the high-curvature curved road.

The determining that the vehicle is likely to depart from the road may include determining that a lateral acceleration of the vehicle is greater than or equal to a first value.

The determining that the driving control is required for the vehicle may include determining that the driving control is required for the vehicle based on lateral acceleration information, speed information, revolutions per minute (RPM) information of an output of the transmission, and gear information of the transmission.

The determining that the driving control is required for the vehicle may include determining that a lateral acceleration of the vehicle is greater than or equal to a second value.

The determining that the driving control is required for the vehicle may include determining that a speed of the vehicle is greater than or equal to a third value.

The determining that the driving control is required for the vehicle may include determining that an RPM of the output of the transmission is less than or equal to a fourth value.

The determining that the driving control is required for the vehicle may include determining that a gear stage of the transmission is greater than or equal to a predetermined gear level.

The method may further include allowing the upshifting based on a predetermined condition being satisfied.

The method may further include determining that the predetermined condition is satisfied based on a speed of the vehicle being greater than or equal to a predetermined speed, an RPM of an output of the transmission being greater than or equal to a sixth value, or a time to collision (TTC) between the vehicle and a neighboring vehicle being less than or equal to a seventh value.

An autonomous vehicle and a method of driving an autonomous vehicle on a high-curvature curved road may, when there is a probability of lane departure as the vehicle is driving on a high-curvature curved road during autonomous driving and a lateral acceleration is above a specific level, and when it is thus determined to be necessary to control the vehicle, inhibit an upshift of a gear stage of the vehicle and prevent the vehicle from driving on the high-curvature curved road at a high speed and departing from its driving lane. It may also, when specific conditions are satisfied during the upshift inhibition, exceptionally allow the upshift within a limited range to prevent behavioral instability of the vehicle and prevent a collision with a neighboring vehicle.

According to the present disclosure described herein, the autonomous vehicle and the method of driving the autonomous vehicle on a high-curvature road may, when the vehicle is traveling on a high-curvature road during autonomous driving and has a certain level or higher of a lateral acceleration to be likely to depart from the road, and controlling the vehicle is thus determined to be required, inhibit an upshift of a gear stage of the vehicle, thereby preventing the vehicle from driving at a high speed on the high-curvature road and departing from the road. It may also, when a certain condition is satisfied during the upshift inhibition, exceptionally allow the upshift of the gear stage within a certain range, thereby preventing behavioral instability of the vehicle and preventing a collision with a neighboring vehicle.

While all of the components of the present disclosure have been described above as combining or operating in combination, the present disclosure is not necessarily limited to such embodiments. All of the components may optionally operate in combination with one or more of the components within the scope of the present disclosure. In addition, as used herein, the terms “include,” “comprise,” and “have” specify the presence of stated features, numbers, operations, elements, components, and/or combinations thereof, but do not preclude the presence or addition of one or more other features, numbers, operations, elements, components, and/or combinations thereof. In addition, when describing the example embodiment(s) with reference to the accompanying drawings, like reference numerals refer to like components and a repeated description related thereto will be omitted. All terms, including technical or scientific terms, unless otherwise defined, have the same meaning as is commonly understood by one of ordinary skill in the art to which the present disclosure pertains. Commonly used terms, such as dictionary-defined terms, are to be construed as consistent with their contextual meaning in the relevant art and are not to be construed in an idealized or unduly formal sense unless expressly defined so in the present disclosure.

While one or more example embodiments of the present disclosure have been shown and described above, the present disclosure is not limited to the example embodiment(s) described above, various changes and modifications may be made by one of ordinary skill in the art to which the present disclosure pertains without departing from the spirit and scope of the disclosure, and such changes and modifications should not be construed as being independent of the technical ideas or views of the present disclosure. Accordingly, the example embodiment(s) of the present disclosure are not described for the purpose of limiting the technical ideas of the present disclosure but only for illustrative purposes and thus do not limit the scope of the technical ideas of the present disclosure. The scope of protection of the present disclosure is to be construed in accordance with the following claims, and all technical ideas within the scope thereof will be construed as falling within the scope of the present disclosure.

What is claimed is:

1. A control device for a vehicle, the control device comprising:
a plurality of processors comprising a first processor, a second processor, and a third processor; and
a memory storing at least one instruction,
wherein the at least one instruction is configured, when executed by the first processor communicating with the memory, to cause the control device to:
based on a map of an area in which the vehicle is traveling, global positioning system (GPS) information associated with the vehicle, and a lateral acceleration of the vehicle, determine that the vehicle, which is traveling on a road with a curvature value above a threshold curvature value, is likely to depart from a driving lane in which the vehicle is traveling,
wherein the at least one instruction is configured, when executed by the second processor communicating with the memory, to cause the control device to:
based on at least one of: the lateral acceleration of the vehicle, a speed of the vehicle, a gear ratio of a transmission of the vehicle, or a rotational speed of the transmission of the vehicle, determine that driving control is required for the vehicle, and
wherein the at least one instruction is configured, when executed by the first processor communicating with the memory, to cause the control device to:
control, based on the determining that the vehicle is likely to depart from the driving lane and the determining that the driving control is required, an autonomous driving operation of the vehicle by inhibiting upshifting in the transmission.

2. The control device of claim 1, wherein the map has a resolution that is above a threshold value or is associated with a navigation device.

3. The control device of claim 1, wherein the at least one instruction is configured, when executed by the first processor communicating with the memory, to cause the control device to determine that the vehicle is likely to depart from the driving lane by:
determining that the lateral acceleration of the vehicle is greater than or equal to a threshold value.

4. The control device of claim 1, wherein the at least one instruction is configured, when executed by the second processor communicating with the memory, to cause the control device to determine that the driving control is required for the vehicle by:
determining that the lateral acceleration of the vehicle is greater than or equal to a threshold value.

5. The control device of claim 1, wherein the at least one instruction is configured, when executed by the second processor communicating with the memory, to cause the control device to determine that the driving control is required for the vehicle by:
determining that the speed of the vehicle is greater than or equal to a threshold value.

6. The control device of claim 1, wherein the at least one instruction is configured, when executed by the second processor communicating with the memory, to cause the control device to determine that the driving control is required for the vehicle by:
determining that the rotational speed of the transmission is less than or equal to a threshold value.

7. The control device of claim 1, wherein the at least one instruction is configured, when executed by the second processor communicating with the memory, to cause the control device to determine that the driving control is required for the vehicle by:
determining that the gear ratio of the transmission is greater than or equal to a threshold value.

8. The control device of claim 1, wherein the at least one instruction is configured, when executed by the third processor communicating with the memory, to further cause the control device to:
control, based on a predetermined condition being satisfied while upshifting in the transmission is inhibited, a second autonomous driving operation of the vehicle by allowing upshifting in the transmission.

9. The control device of claim 8, wherein the predetermined condition comprises at least one of:
the speed of the vehicle being greater than or equal to a threshold speed,
the rotational speed of the transmission being greater than or equal to a threshold rotational speed, or
a time to collision (TTC) between the vehicle and a target vehicle being less than or equal to a threshold time duration.

10. A method performed by an apparatus of a vehicle, the method comprising:
starting a cruise control operation of the vehicle;
determining that the vehicle is traveling on a high-curvature road having a curvature value above a threshold curvature value;
determining, by an autonomous driving controller of the apparatus and based on a determination that the vehicle is traveling on the high-curvature road, that the vehicle is likely to depart from a driving lane in which the vehicle is traveling;
determining, based on a determination that the vehicle is likely to depart from the driving lane, that driving control is required for the vehicle; and
controlling, based on a determination that the driving control is required for the vehicle, an autonomous driving operation of the vehicle by inhibiting upshifting in a transmission of the vehicle.

11. The method of claim 10, wherein the determining that the vehicle is traveling on the high-curvature road comprises:
determining that the vehicle is traveling on the high-curvature road based on a map, wherein the map has a resolution that is above a threshold value or is associated with a navigation device.

12. The method of claim 10, wherein the determining that the vehicle is likely to depart from the driving lane comprises:
determining that a lateral acceleration of the vehicle is greater than or equal to a threshold value.

13. The method of claim 10, wherein the determining that the driving control is required for the vehicle comprises:
determining that the driving control is required for the vehicle based on at least one of: a lateral acceleration of the vehicle, a speed of the vehicle, a rotational speed of the transmission, or a gear ratio of the transmission.

14. The method of claim 10, wherein the determining that the driving control is required for the vehicle comprises:
determining that a lateral acceleration of the vehicle is greater than or equal to a threshold value.

15. The method of claim 10, wherein the determining that the driving control is required for the vehicle comprises:
determining that a speed of the vehicle is greater than or equal to a threshold value.

16. The method of claim 10, wherein the determining that the driving control is required for the vehicle comprises:
determining that a rotational speed of the transmission is less than or equal to a threshold value.

17. The method of claim 10, wherein the determining that the driving control is required for the vehicle comprises:
determining that a gear ratio of the transmission is greater than or equal to a threshold value.

18. The method of claim 10, further comprising:
controlling, based on a predetermined condition being satisfied while upshifting in the transmission is inhibited, a second autonomous driving operation of the vehicle by allowing upshifting in the transmission.

19. The method of claim 18, wherein the predetermined condition comprises at least one of:
a speed of the vehicle being greater than or equal to a threshold speed,
a rotational speed of the transmission being greater than or equal to a threshold rotational speed, or
a time to collision (TTC) between the vehicle and a target vehicle being less than or equal to a threshold time duration.

20. A control device for a vehicle, the control device comprising:
at least one sensor comprising an inertial measurement sensor and a camera;
a processor; and
a memory storing at least one instruction that is configured, when executed by the processor communicating with the memory, to cause the control device to:
start a cruise control operation of the vehicle;
determine, based on measurements of the inertial measurement sensor and at least one image captured by the camera, that the vehicle is traveling on a high-curvature road having a curvature value above a threshold curvature value;
during an autonomous driving operation of the vehicle, determine, based on a determination that the vehicle is traveling on the high-curvature road, that the vehicle is likely to depart from a driving lane in which the vehicle is traveling;
determine, based on a determination that the vehicle is likely to depart from the driving lane, that driving control is required for the vehicle; and
control, based on a determination that the driving control is required for the vehicle, an autonomous driving operation of the vehicle by inhibiting upshifting in a transmission of the vehicle.
